(19) United States
(12) Patent Application Publication
(10) Pub. No.: US 2006/0104742 A1
(43) Pub. Date: May 18, 2006

(54) Stud for parts assembly

(76) Inventor: David Thomas Fleming, Scottsville, KY (US)

Correspondence Address: James M. Francis;Ste 507, 271 W Short St., Lexington, KY, 40507-1214, US

(21) Appl. No.: 10/987,996

(22) Filed: Nov. 12, 2004

(51) Int. Cl. F16B 35/00

(52) U.S. Cl. 411/389

(57) ABSTRACT

An improved stud for assembling an engine valve cover or other mechanical parts together comprised of an elongated shaft having two end portions and at least one intermediate threaded portion therebetween. At least one end portion of the stud has a drive receiving recess formed therein. The intermediate threaded portion may be a single continuous thread or two distinct threads. The pitch and spacing on the thread or threads need not be identical and are ideally matched to the receiving threads of an orafice. The drive pocket in the head of the stud allows the shaft to be installed and removed by applying torque to the end and not to the body of the stud along the shaft. The stud may also be securely held so as not to be loosened or removed from one set of receiving threads into which it is installed while an object is installed or removed from the threads on the opposing end.

### BACKGROUND OF THE INVENTION

1. Field of the Invention

This invention relates to a threaded stud with a drive recession in at least one end of the stud shaft. The stud may be threaded with a continuous thread along the shaft or may utilize more than one thread of the same or different pitches and spacing. The stud is twisted into a threaded orafice by inserting a fitted drive tool into the drive pocket and applying rotational force at the end of the stud. The drive tool can also hold the stud stationary while a nut or similar object is installed or removed from the stud shaft.

The drive recession in the head or opposing end of the stud shaft may be of any design to receive a fittedly designed tool matching said recession. Non-limiting examples of such a recession are an Allen head or Star head shaped recession. Anticipated uses include, but are not limited to, a fastening or securing means for home, industrial, and automotive applications.

2. Problems in the Art

Studs have long been utilized to assemble objects such as engine parts. One end of the stud is received into the threads of a first object while the opposing end of the stud passes through an aperture in a second object and is secured by a nut which compresses the first object and second object together. Often a gasket or other type of seal is placed between the adjoining surfaces of the first object and second object. Additional gaskets or seals may subsequently be utilized between objects adjoining the first and or second objects. While existing studs function quite well at keeping assembled objects together, they present difficulties during installation and removal as there is no good way to grip the end of the stud without risking damage to the threads. Many studs have continuous threading, thus making the threads the only available contact point for gripping the stud. The ability to grip the stud from the end will assist not only in installation and removal but also allow the stud to be held stationary while a nut is removed from one end.

It is often advantageous for one object of an assembly to remain stationary while an adjoining object is separated from it. This is often the situation when joined objects form a seal or are precisely positioned such that it is advantageous to not move the joined objects or break the seal.

Numerous methods to improve the usefulness of studs are described in the literature. But none describe the need to provide for removal of nuts or other compression pieces while the shaft remains motionless. U.S. Pat. No. 5,647,710, Bolt With Removable Head, by Cushman (Jul. 15, 1997), describes a bolt with removable caps on opposing ends of the shaft. The bolt shaft and the caps have Allen wrench drive recessions formed therein. However, the Cushman invention is a bolt and not a stud, thus is designed to apply compression by twisting into an object while a stud is intended to apply compression in only one axis. The significance of apply force along one axis is in the ability to obtain more accurate torque readings. Also, there is less force exerted on the threads of the assembled objects, thus extending the remaining useful life of the assembled parts or objects. The Cushman invention only utilizes Allen drives and does not allow for the use of two different thread pitches and spacing or reverse pitches on opposing ends of the shaft as does the present invention.

U.S. Pat. No. 5,560,265, Rocker Arm Mounting Stud, by Miller (Oct. 1, 1996), describes a stud used to mount engine rocker arms. The rocker arm is vertically adjusted using the Allen head attachment screwed onto the top of the stud and a lower stop comprised of a nut. The Miller invention does not possess an integrated Allen head drive and does not solve the problem of removing part of the assembly while maintaining the stud position in the remaining assembly objects.

While these devices fulfill their respective objectives and requirements they do not describe a stud with an Allen head recession or drive utilized to keep the stud stationary while a nut is removed or applied to the shaft of the stud.

### SUMMARY OF THE INVENTION

The invention is directed to the use of a cylindrical stud with an Allen, Star, or similar drive recession, drive pocket, or drive receiving aperture in at least one end. This aids in providing a gripping or drive point from which the shaft may be turned or secured without damaging the threads along the stud shaft. Such a stud improves the ease with which objects may be assembled and disassembled while preventing articulation of parts the user desires to keep stationary.

Engine assemblies and other assembled objects often require force to be applied along one axis rather than by rotational torque. In order to achieve single axis compression, a stud is used instead of a bolt. Thus a nut is twisted along the shaft of the stud to apply pressure or force along a single axis instead of having a stationary fixed bolt head which applies pressure or force as it is turned and engages the internal threads of vital parts or objects.

As studs are installed and removed from assemblies, it is often preferred that the stud only engages or disengages one threaded object or part while not affecting the threaded relationship with a second threaded object or part. This is demonstrated by the installation of a stud into an engine block and the operable engagement of a fastening nut on the opposing end of the stud shaft. If the stud tightens in the block upon operating a nut at the other end of the stud, it might seize and become difficult or impossible to remove. Alternatively, the stud may back out of the engine block by disengaging from the receiving threads and weaken the assembly without the mechanic's knowledge. It is also preferred that the end of the stud be flush with the outer surface of the assembly which further complicates gripping the stud.

The construction of the stud is preferably steel but could also be aluminum or any metal, metal alloy, ceramic, hardened plastic or suitable material matched to the application of the stud.

It is an object of this invention to provide a stud with means for turning the shaft from the end rather than along the length of the shaft.

It is a further object of this invention to provide a stud with means to be held stationary from the end while a nut is removed from the threaded portion of the shaft.

It is a further object of this invention to provide a stud that will facilitate disassembly and reassembly of assembled objects, such as engine parts.

These and other objects, features, and advantages of the present invention will become more apparent with reference to the accompanying specification and claims.

### BRIEF DESCRIPTION OF THE DRAWINGS

FIG. 1 depicts a perspective view of the preferred embodiment of the present invention.

FIG. 2 depicts an end view of the preferred embodiment of the present invention.

FIG. 3 depicts a cross-sectional view of the preferred embodiment of the present invention.

### DETAILED DESCRIPTION

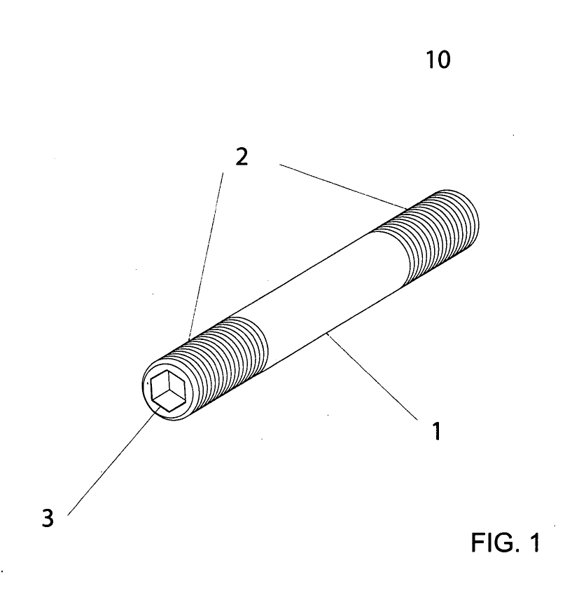

With reference to FIG. 1, a preferred embodiment of an improved stud in accordance with the present invention is shown by reference numeral 10, the basic structure of which includes a cylindrical shaft 1, threaded surfaces 2 on opposing ends of the shaft 1, and a drive recession, drive pocket, or drive receiving aperture 3.

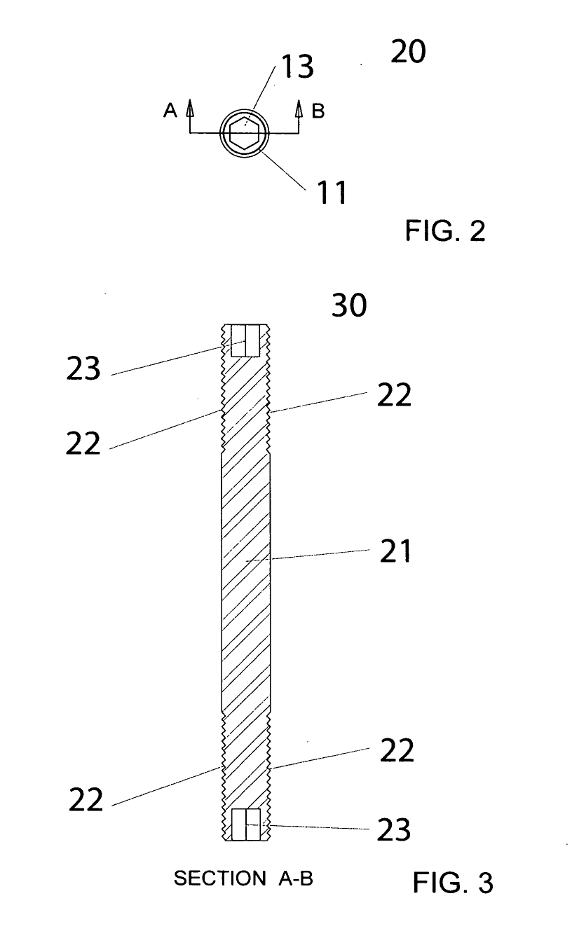

With reference to FIG. 2, the drive recession, drive pocket, or drive receiving aperture 13 can be seen in this end view of the cylindrical shaft 11 of the present invention 20. A plane across the width of the shaft 11 is depicted along the A-B plane.

With reference to FIG. 3, the preferred embodiment of the present invention 30 is depicted as a cross-section along the shaft 21 and the A-B plane of FIG. 2. Depicted are the drive recession, drive pocket, or drive receiving aperture 23 that is intended in this embodiment to receive an alien head drive, a threaded surface 22.

What is claimed is:

1. A stud comprising;
(a) a cylindrical shaft, said shaft having a length, a diameter, and a circumference;
(b) first and second ends of said shaft;
(c) said first and second ends being roughly planar and perpendicular to said shaft;
(d) said first and second ends having a diameter no larger than that of said shaft;
(e) at least one threaded portion along the surface of said shaft between said first and second ends, said thread extending from the length of said shaft to said first or second end; and
(f) a drive pocket in at least one said end.

2. The device of claim 1, wherein at least one said end is designed to be sunk flush to the surface of the object into which it is engaged.

3. The device of claim 2, wherein said shaft surface has first and second threaded ends.

4. The device of claim 3, wherein said first and second threaded ends are of incompatible design such that the ends are not interchangeable with the internally threaded components into which they are received.

5. The device of claim 1, wherein said stud is welded to part of an assembly at one said end of said stud.

6. The device of claim 1, wherein said stud is comprised of metal.

7. The device of claim 7, wherein said metal is selected from the group consisting of iron, steel, aluminum, copper, lead, and similar metals and alloys.

8. The method of stud installation and removal comprising:
(a) operating a first threadably engaged object along the shaft of a threaded stud that is threadably engaged with a second threaded object;
(b) holding said stud rotationally stationary by the application of force in opposition to the torque produced by operating said first threadably engaged object along the shaft of said threaded stud while not operating said second threadably engaged object along said threaded stud; and
(c) applying said opposing force through a drive tool inserted within a drive pocket located in at least one end of said shaft.
